(19) United States
(12) Patent Application Publication
(10) Pub. No.: US 2005/0005677 A1
(43) Pub. Date: Jan. 13, 2005

(54) Method and apparatus for environmental monitoring and data logging

(76) Inventor: Kirk R. Smith, Berkeley, CA (US)

Correspondence Address: BEYER WEAVER & THOMAS LLP, P.O. BOX 778, BERKELEY, CA, 94704-0778, US

(21) Appl. No.: 10/855,793

(22) Filed: May 26, 2004

Related U.S. Application Data
(60) Provisional application No. 60/475,023, filed on May 30, 2003.

(51) Int. Cl. G01N 15/00; G01N 15/02; G01N 15/06

(52) U.S. Cl. 73/28.02; 73/865.5

(57) ABSTRACT

An economical particle monitor for use in measuring particulate matter in the atmosphere includes two detection chambers: an ionized atmosphere between two electrically biased plates with particulate matter affecting current flow through the ionized atmosphere between the plates and a light-scattering chamber in which light from a light-emitting diode is scattered from introduced particles and detected by a photo-electric detector. Measures of current flow are provided to a data logger as a measure of particulate matter in the atmosphere, and the data logger maintains a record of measured particulate matter along with temperature and humidity. Alternatively, the signals could be provided to an analog (dial) or digital display for instant read out. A plurality of detectors can be provided with each detector being sensitive to particles of a specific size range and concentration range. The recorded data of the data logger is periodically downloaded to a personal computer for analysis and reporting

### CROSS-REFERENCE TO RELATED APPLICATIONS

This application claims priority under 35 U.S.C. § 119(e) from Provisional Application Ser. No. 60/475,023, filed May 30, 2003, which is incorporated herein by reference for all purposes.

### BACKGROUND OF THE INVENTION

This invention relates generally to monitoring environmental conditions, and more particularly the invention relates to monitoring particulate matter in the atmosphere and maintaining a data log on environmental conditions.

Particle pollution in the approximately half of the world households using solid fuels such as coal and biomass for cooking and space-heating in simple stove is thought to be a major cause of ill-health in poor countries, being responsible for more a million premature deaths annually in women and children according to the World Heath Organization. Relatively little is known, however, about the distribution of the actual pollution levels involved, to a great extent because existing monitoring equipment is either inappropriate or much too costly because it has been designed for developed-country applications.

Measurement of particulate matter for population surveys in developing world settings using current technologies presents several difficulties. Normal gravimetric sampling requires the use of an environmentally controlled weigh room, and careful and skilled handling of pumps, balances, and filters. Thus, skilled technicians are needed for the surveys and combined with multiple visits for filter changing, battery replacement, and calibration causes a burden on participants, potentially biasing household behaviors, and complicating logistics. Currently available real time data logging particle monitors using light-scattering technology are prohibitively expensive, and are designed for particulate levels at least in order of magnitude lower and more difficult to measure that those experienced in residential settings in developing countries.

### SUMMARY OF THE INVENTION

The present invention provides an economical continuous particle monitor for application in developing world settings to measure household pollution levels from cook stoves and other sources.

Availability of such a monitor allows a greatly expanded knowledge base about existing conditions, and also facilitates monitoring and evaluations and of interventions such as improved fuels, stoves, and ventilation. By incorporating data logging technology the invention also enables more sophisticated investigation of the relationship between pollution levels and various forms of ill-health, for example whether peak or average exposures are better indicators.

The invention and objects and features thereof will be more readily apparent from the following detailed description and appended claims when taken with the drawings.

### BRIEF DESCRIPTION OF THE DRAWINGS

FIG. 1 is a functional block diagram of a particle monitor and data logger in accordance with one embodiment of the invention.

FIG. 2 is a functional block diagram of another embodiment of the invention in which a plurality of particle monitors are employed with a data logger for monitoring of particles of various sizes.

### DETAILED DESCRIPTION OF ILLUSTRATIVE EMBODIMENTS

The invention provides a cost effective particle detector and environmental data logger. The particle detector can employ either or both detector chambers found in conventional smoke detectors:
a. Ionization chamber in which a source of ionizing radiation which causes a small current to flow between charged plates of an ionization chamber by creating ions from air molecules. This current is sensed by the electronics of the detector. When particles enter and absorb part of the radiation, a monitored current is altered, which provides a measure of the amount of particulate matter being detected.
b. Light-scattering chamber in which a light-emitting diode emits light into a chamber where particles in the surrounding air penetrate. The light scattered from the particles is detected by a photo-electric sensor and converted to an electrical signal.

In the ionization chamber, the source of ionizing radiation is a very small amount of Americium-241 emitting an extremely small amount of alpha radiation. Alpha rays are non-penetrating, and thus are even blocked by a sheet of paper, a few centimeters of air, or the skin. The dioxide of Americium-241, the form present in smoke detectors, is insoluble in water and will pass through the digestive tract without delivering a significant radiation dose. Thus, Americium-241 in the detector does not pose a danger to heath unless broken apart and inhaled. In a particle detector it poses no more health hazard to the participants than do commercial smoke detectors found in homes worldwide.

Both chambers in the particle monitor are passive since there is no active pumping of the air across the detectors. This has several advantages; firstly, it eliminates the needs for pumps, batteries, and other equipment that need to calibrated and maintained by skilled personnel. Secondly, elimination of the pump allows for a much more economical sampling device. Thirdly, the device can have much reduced size, weight, and noise, which lends itself to personal exposure monitoring and long term in placement in residences.

Particle size is a factor in particle monitoring. Although solid-fuel combustion produces the small particles (less than 2-3 microns in size) thought to be most damaging to health, larger particles also are present in households, mainly associated with dust and dirt. Ideally, these larger particles are measured separately or are excluded from the measurement. By their basic physics, the ionization chamber is not sensitive to particle larger than a micron or so in size and the sensitivity of the light-scattering chamber drops off rapidly at sizes larger than 2-3 microns. However, the ionization chamber is suitable for measuring the most health-damaging particles.

For third-world use, it is preferable for the monitor to detect small particle concentrations ranging from approximately 50 to 30,000 μg/m³ for one hour or shorter averaging times. For first-world use, sensitivity should be in the range of 5-500 μg/m3. It should have correlations coefficients (r-squared) of at least 0.9 with standard commercial light-scattering devices and at least 0.8 with standard high-quality gravimetric sampling. For most flexibility, the device should use standard batteries (e.g., 9V) and long field life on a battery (weeks).

The particle monitor is combined with technology to store the measured data during the sampling period and during transport from the field for subsequent downloading in a central location. This limits the highly-skilled activities and manipulation required of the field personnel, and equipment needed to be transported into the field. In addition, it minimizes disruption and burdening of participants and increases willingness to participate. The collection and storage of data is inexpensive and readily available microprocessor chips (e.g. BASIC stamp). These are small single board computers that can be adapted for field use.

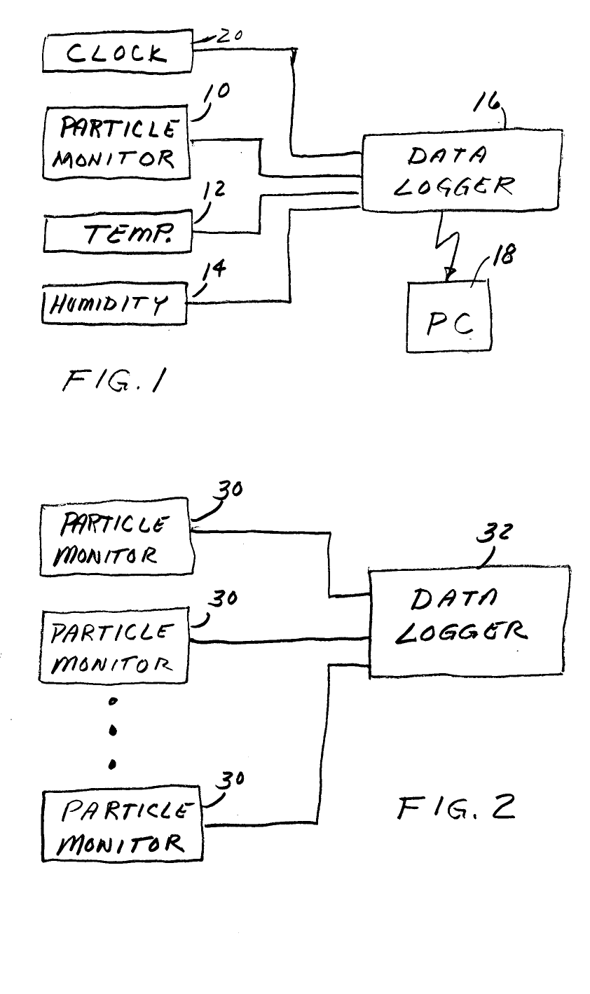

Several levels of complexity can be provided starting from the most simple and most economical. All are based on the same basic design, however, and increased complexity derives from measurement of additional parameters. FIG. 1 is a block diagram of one embodiment including particle monitor 10 with light-scattering chamber, temperature sensor 12, humidity sensor 14, and microprocessor 16 for three channel data logging applicable for both micro environment and personal monitoring. A fourth channel for ionization chamber data can be added. Data logger 16 can download recorded data to a personal computer 18 for further processing and the submission of reports, for example. Clock 20 is shown external to data logger 16 but can be included as an integral part of the data logger. Particle monitor 10 can be a conventional smoke detector with the detected particles affecting current flow which provides a measure of particulate matter. Data logger 16 can be a commercially available product such as the BASIC stamp, supra. Alternatively, the data logger and memory can be replaced by a meter or digital readout.

In application, a plurality of particle monitors and data loggers, as shown in FIG. 1 are used simultaneously in FIG. 2, with each particle monitor 30 limited in monitored particle size. There are devices such as cyclones and impactors that can be used as particle size selecting means. As noted above, particle concentrations can range from 50 to 30,000 μg/m3 for third-world use and 5-500 μg/m³ for first-world use Data logger 30 can comprise a plurality of data logger chips 16 of FIG. 1.

As noted above, the monitored current in an ionization detector flows between two plates with a voltage across the plates and a radioactive source such as Americium-241 providing ionizing radiation. The alpha particles generated by the Americium ionize oxygen and nitrogen atoms in the air of the chamber with free electrons and positive charges creating a current between the positive and negative plates of the detector. The electronics sense the small amount of electrical current from the flow of these electrons and ions and the variation in electrical current are due to the presence of particulate matter. When particles enter the ionization chamber, the current is affected since the particles tend to attach to the ions and neutralize them. The detector then senses a drop in current between the plates. The light scattering chamber operates in a similar fashion but uses light scattering and a photo electric sensor.

A range of other applications can be provided including a personal monitor including heart rate. Additional environmental parameters can include stove/fire temperature, CO monitor, and CO₂ monitor to combine with CO measurement for flue gas, CO/CO₂ ratio, for example.

A specification for a basic monitoring unit is as follows:

Particle Measurement:

Size sensitivity aerodynamic diameter less than 2.5 μm
Sensor: Single or dual chamber (ionization and light-scattering) smoke detectors
Sensitivity: 50 to 30,000 μg/m3 for third-world uses; 5-500 μg/m³ for first world use High correlations (R2>0.9) with commercial light-scattering instruments;
(R2>0.8 for gravimetric sampling)Initial stabilization: <10 sec
Response time: <10 sec
Measurement interval: adjustable from 1 sec to 1 hour
Power consumption: batteries to last at least 2 weeks at 1 minute monitoring/storage intervals
Temperature and humidity to be monitored as well
Operating Humidity: 95% max
Operating Temperature range: 0-50 C—ideal operating range 25-35 C.
   Data Logging:
Direct download to PC
Programmable recording parameters
Time+date record
At least 2 weeks of 1 minute data for all four channels
Capable of having direct readout (analog or digital)
   Combined Dimensions:
Weight: 250 g
Dimensions: No larger than standard smoke alarm, preferably smaller
LED to indicate function
Enclosed unit (plastic) reasonably tamperproof and durable for transport
Unit to be powered by 9V or other commonly available battery
Attachment for securing to wall/table etc
   Total Cost: 150 US Dollars

The detector can use either or both an ionization chamber and a light-scattering chamber in detecting particles. Thus, while the invention has been described with reference to specific embodiments, the description is illustrative of the invention and is not to be construed as limiting the invention. Various modifications and applications may occur to those skilled in the art without departing from the true spirit and scope of the invention as defined by the appended claims.

1. An environmental monitor comprising:
(a) a detector of particulate matter in an atmosphere that provides a signal representing measure of the particulate matter, and
(b) a data logger for receiving the signal from the detector and maintaining a record of measured particulate matter.

2. The environmental monitor of claim 1 wherein the detector includes means for ionizing atmosphere within the detector.

3. The environmental monitor as defined by claim 2 wherein the detector further includes at least two spaced and electrically biased plates with the ionized atmosphere there between, the ionized atmosphere providing a current flow between the plates with particulate matter affecting the magnitude of current flow.

4. The environmental monitor as defined by claim 3 wherein the data logger records a measure of current flow between plates in the detector as a measure of particulate matter in the atmosphere.

5. The environmental monitor as defined by claim 4 wherein the detector is sensitive to particles of a specific size range.

6. The environmental monitor as defined by claim 5 and further including a plurality of detectors each sensitive to particles of different size ranges when combined with standard particle size selection devices

7. The environmental monitor as defined by claim 4 wherein the detector is sensitive to particles of a specific concentration range.

8. The environmental monitor as defined by claim 7 and further including a plurality of detectors each sensitive to particles of a different specific concentration range.

9. The environmental monitor as defined by claim 1 and further including a temperature sensor, the data logger maintaining a record of measured temperature.

10. The environmental monitor as defined by claim 9 and further including a humidity sensor, the data logger maintaining a record of measured humidity.

11. The environmental monitor as defined by claim 10 and further including a clock, a data logger recording time as providing by the clock.

12. The environmental monitor as defined by claim 1 and further including a clock, a data logger recording time as providing by the clock.

13. The environmental monitor as defined by claim 1 wherein the detector includes a light-scattering chamber for detecting particles.

14. The environmental monitor as defined by claim 13 wherein the detector further includes means for ionizing atmosphere within the detector.

15. An environmental monitor comprising:
a) a detector of particulate matter in an atmosphere that provides a signal representing measure of the particulate matter, and
b) means for receiving the signal and providing a readout of particulate matter.

16. The environmental monitor as defined by claim 15 wherein the means for providing a readout of particulate matter comprises a meter.

17. The environmental monitor as defined by claim 16 wherein the means for providing a readout further include a data logger.
